(19) United States
(12) Patent Application Publication
(10) Pub. No.: US 2005/0166354 A1
(43) Pub. Date: Aug. 4, 2005

(54) Autonomous vacuum cleaner

(75) Inventor: Naoya Uehigashi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/043,083

(22) Filed: Jan. 27, 2005

(30) Foreign Application Priority Data
Jan. 30, 2004 (JP) 2004-022408

(51) Int. Cl. A47L 5/00

(52) U.S. Cl. 15/319

(57) ABSTRACT

An autonomous vacuum cleaner comprises: obstacle detection sensors; moving means; a cleaning means including a power brush, a suction fan and a nozzle for sucking up dust on a floor surface; floor surface sensors each comprising a passive-type CMOS line sensor to receive light from the floor surface for detecting floor surface conditions. It performs cleaning while autonomously moving. Based on received light signals of the floor surface sensors, distance distributions to floor surface areas within the viewing angle of each sensor are derived. Detection of a step on the floor surface and identification of the material of the floor surface (polished floorboard, tatami or carpet) are performed by analyzing spatial frequency in the distance distribution. Based on the identification, cleaning conditions including at least the moving speed, the dust suction force of the suction fan or the brushing strength of the power brush are changed. With simple structure using one same floor sensor, this autonomous vacuum cleaner can detect a step on a floor surface and can more accurately identify the material of the floor surface, thereby enabling meticulous cleaning.

### BACKGROUND OF THE INVENTION

1. Field of the Invention

The present invention relates to an autonomous vacuum cleaner.

2. Description of the Related Art

In a conventional autonomous vacuum cleaner for cleaning a floor surface, floor sensors are used to check the floor surface where the vacuum cleaner moves around and sweeps. For example, such a floor sensor is known which comprises an ultrasonic sensor transmitting an ultrasonic signal to the floor surface and receiving the ultrasonic signal reflected from the floor surface, which is used in a manner that the ultrasonic signal reciprocating between the ultrasonic sensor and the floor surface plural times is integrated by an integrating circuit, and the level of the integrated signal is determined to identify the kind of the floor surface, and to control the operation of a power brush dedicated to carpet cleaning (refer to e.g. Japanese Patent No. 2820407).

Further, a floor sensor is known which comprises an ultrasonic sensor mounted on the front of a drive unit of a vacuum cleaner, which functions as both a step detecting means and a floor surface identifying means, that is, the sensor detects steps on the floor if exist, and at the same time discriminates a carpeted floor from a bare floor based on reflection conditions of the floor surface for the ultrasonic signal (refer to e.g. Japanese Laid-open Patent Publication No. 2003-116756).

However, according to such floor sensors using an ultrasonic sensor as disclosed in the patent references above, it is possible to obtain magnitude information of only averaged reflectivity (or absorptivity) of the ultrasonic signal on the floor surface. Thus there still exists a problem that it is not possible to accurately identify the material or kind of the floor surface.

### SUMMARY OF THE INVENTION

An object of the present invention is to provide such an autonomous vacuum cleaner comprising a floor sensor of simple structure which can detect a step on a floor surface and also can accurately identify the material of the floor surface by using one same floor sensor, thereby enabling meticulous cleaning.

According to the present invention, the above object is achieved by an autonomous vacuum cleaner comprising:
a cleaning means to clean a floor surface where the cleaner moves;
an obstacle detection sensor to detect an obstacle on the cleaner's way and to measure distance to the obstacle;
a moving means with which the cleaner moves autonomously in accordance with an output of the obstacle detection sensor to avoid the obstacle;
a light receiving sensor having a passive-type line sensor to receive light from a floor surface; and
a floor surface distance calculating means which derives distribution of distances to the floor surface within a viewing angle of the light receiving sensor on the basis of correlation between received light intensities on two light receiving areas of the line sensor,
wherein the moving means and the cleaning means are controlled on the basis of the distance distribution derived by the floor surface distance calculating means.

According to this autonomous vacuum cleaner of the present invention, signals received by the passive-type line sensor, which has a higher resolution than e.g. an ultrasonic sensor, are subjected to calculation when the cleaner moves autonomously by avoiding obstacles detected by the obstacle detection sensor and by recognizing the self-position and cleans a predetermined area, whereby a distribution of distances to the floor surface is derived more accurately than the prior art. Since the moving means and the cleaning means are controlled on the basis of thus derived or calculated distance distribution to the floor surface, the cleaner can clean efficiently and move stably in accordance with the condition of the floor surface.

Preferably, the autonomous vacuum cleaner further comprises a floor surface identifying means to identify material of the floor surface on the basis of the distance distribution derived by the floor surface distance calculating means, wherein the moving means and the cleaning means are controlled depending on the material of the floor surface identified by the floor surface identifying means.

According to this preferred mode, the moving means and the cleaning means are controlled further depending on the material of the floor surface, thereby enabling more meticulous operation for desired cleaning results.

Further preferably, the passive-type line sensor is of CMOS, and the cleaning means includes:
a power brush having a rotating shaft extending in a width direction perpendicular to the moving direction of the cleaner to brush the floor surface;
a suction fan to generate dust suction force; and
a nozzle being provided in the vicinity of and substantially in parallel to the power brush to suck up dust on the floor surface using the suction force of the suction fan, and thereby to clean the floor surface where the cleaner moves.

According to this further preferred mode, signals received by the CMOS passive-type line sensor, which has a higher resolution and more simple structure than e.g. an ultrasonic sensor, are subjected to calculation and an accurate distance distribution is obtained which enables more detailed control of the moving means and the cleaning means. The cleaning means can clean powerfully with a power brush and a nozzle of wide extension.

Further preferably, the autonomous vacuum cleaner further comprises a cleaning condition changing means to change cleaning conditions including at least one of the moving speed of the cleaner, dust suction force of the suction fan, or brushing strength of the power brush on the basis of the floor material identification made by the floor surface identifying means during the cleaning,
wherein the floor surface identifying means identifies: that there is a step on the floor surface if there exists larger distance variation than a predetermined distance in the distance distribution; that the material of the floor surface is a polished floorboard if a main spatial frequency of the distance variation is substantially zero; that the material of the floor surface is a tatami if the main spatial frequency is low; and that the material of the floor surface is a carpet if the main spatial frequency is high, and
wherein the light receiving sensor is used both as a step detection sensor and a floor surface identification sensor.

According to this further preferred mode, it is possible to identify the material of the floor (polished floorboard, tatami, or carpet) more accurately than the prior art. And it is also possible to detect a step on the floor surface with the same sensor used for floor surface identification, thereby enabling reduction of sensor cost.

Furthermore, since the material of the floor surface can be accurately identified, it is possible to protect the floor surface from damage by changing the cleaning conditions depending on the kind of the floor surface material, and possible to efficiently realize cleaned state of the floor surface as desired.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic electrical block diagram of an autonomous vacuum cleaner according to an embodiment of the present invention;

FIG. 2 is a schematic and partially cutaway side view of the autonomous vacuum cleaner;

FIG. 3A is a schematic perspective view of an upper part of the autonomous vacuum cleaner, while FIG. 3B is a schematic perspective view of a lower part of the autonomous vacuum cleaner;

FIG. 4 is a schematic top plan view of the autonomous vacuum cleaner;

FIG. 5 is a schematic front view of the autonomous vacuum cleaner;

FIG. 6 is a schematic cross-sectional view of a floor sensor (light receiving sensor) to be used in the embodiment of the present invention, showing its distance measurement principle;

FIG. 7 is a graph of distributions of received light intensity, showing an example of output signal of the floor sensor;

FIG. 8A through FIG. 8D are schematic cross-sectional views showing situations of measurements using the floor sensor;

FIG. 9A through FIG. 9D are conceptual views of various floor surfaces, showing differences in their conditions as visually observed;

FIG. 10A through FIG. 10D are graphs of obtained distance distributions on the basis of output signals of the floor sensor; and

FIG. 11 is a flow chart showing a cleaning process of the autonomous vacuum cleaner.

### DESCRIPTION OF THE PREFERRED EMBODIMENTS

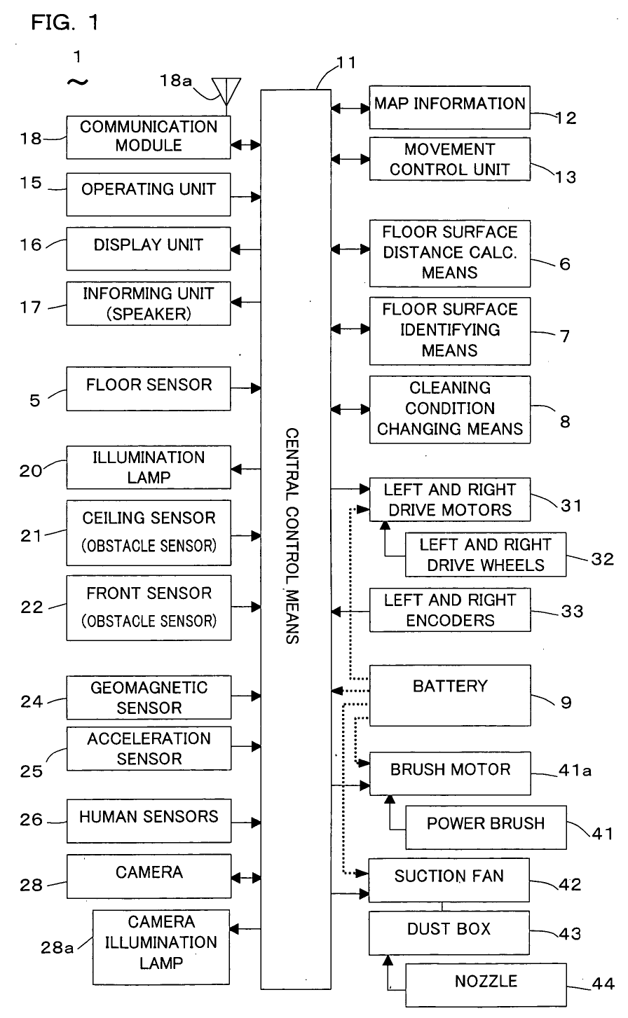

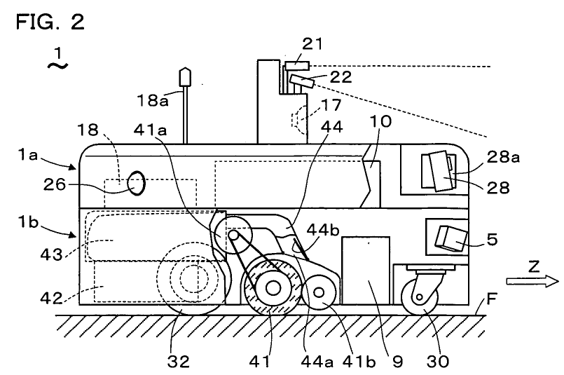

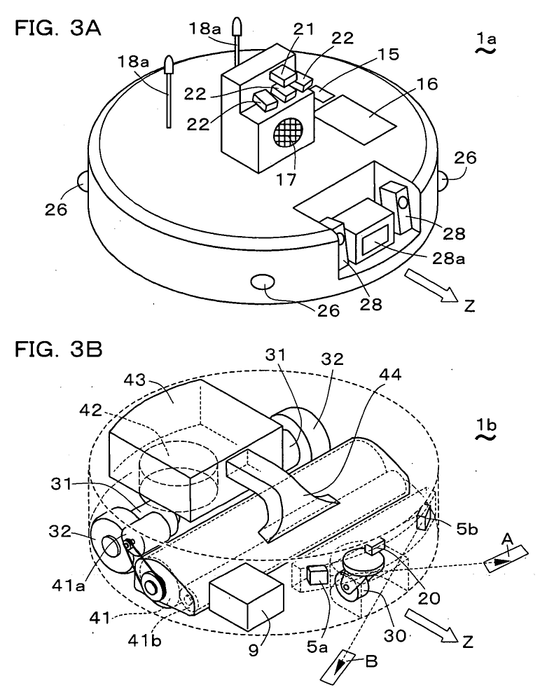

An autonomous vacuum cleaner according to an embodiment of the present invention will be described hereinafter with reference to the annexed drawings. FIG. 1 shows an electrical block diagram of an autonomous vacuum cleaner 1 according to the present embodiment. FIG. 2 shows a partially cutaway side view of the autonomous vacuum cleaner 1. FIG. 3A and FIG. 3B show an upper part and a lower part of the autonomous vacuum cleaner 1, respectively, as separated.

As shown in FIG. 3A and FIG. 3B, the autonomous vacuum cleaner 1 is a three-wheeled vehicle having an outer shape formed of two disk-shaped parts, namely a cleaner-upper-part 1a and a cleaner-lower-part 1b, stacked vertically on each other. The cleaner-upper-part 1a comprises mainly various sensors and control devices, while the cleaner-lower-part 1b comprises a moving means and a cleaning means. In the following, the autonomous vacuum cleaner 1 will be described by referring mainly to the electrical block diagram of FIG. 1, and in some instances by referring also to FIG. 2, FIG. 3A and FIG. 3B, as to its autonomous movement function, peripheral function and cleaning function, and then as to its identification function for the material of the floor surface.

The autonomous vacuum cleaner 1 comprises a ceiling sensor 21 and front sensors 22. Those are optical distance sensors for detecting e.g. obstacles for the cleaner 1 to move autonomously, and which are provided on a projecting portion on an upper surface of the cleaner-upper-part 1a as shown in FIG. 2 and FIG. 3A. The cleaner 1 also comprises light receiving sensors, that is, floor sensors 5 (sensors 5a and 5b) and an illumination lamp 20 on a front portion of the cleaner-lower-part 1b. The floor sensors 5 will be described later in more detail. The ceiling sensor 21 monitors the space in front of the autonomous vacuum cleaner 1 in the horizontal direction, and detects obstacles located in front of the cleaner 1 (as to whether or not it can pass through under a table, a bed or the like), and further measures heights of and distances to the obstacles. The front sensors 22 monitor the area in front of the autonomous vacuum cleaner 1 downward diagonally (in moving direction Z), and measure distances to obstacles such as a step, a wall, a pillar, a furniture, legs of a table and a bed, and so on that are positioned on a moving path of the cleaner 1 and in its vicinity.

The cleaner-upper-part 1a of the autonomous vacuum cleaner 1 comprises a control device box 10, inside of which (not shown) a geomagnetic sensor 24 and an acceleration sensor 25 are provided for the cleaner 1 to move autonomously. The acceleration sensor 25 independently detects accelerations acting on the cleaner 1 as it moves in three directions of up-down, forward-backward and left-right, respectively. The geomagnetic sensor 24 outputs signals correlated with the direction of the geomagnetic field to decide the direction in which the cleaner 1 faces.

As shown in FIG. 2 and FIG. 3B, the autonomous vacuum cleaner 1 comprises left and right drive motors 31 and left and right drive wheels 32 that are provided as a moving means positioned in the rear of moving direction Z of the cleaner-lower-part 1b. The autonomous vacuum cleaner 1 also comprises a front idler wheel 30 for its movement in addition to the left and right drive wheels 32. Each of the left and right drive wheels 32 is independently driven by drive motors 31 in normal rotation or reverse rotation by using a battery 9 as a power source, and the cleaner 1 is steered by controlling the rotation number of each of the drive wheels 32. The rotation numbers are measured by using left and right encoders 33 attached to the left and right drive motors 31.

Inside the control device box 10 shown in FIG. 2, the autonomous vacuum cleaner 1 further comprises a central control means 11, map information 12 and a movement control unit 13 together with other circuits and peripheral devices for control. The central control means 11 and the movement control unit 13 are composed of an MPU (Micro Processing Unit), peripheral devices and software. The map information 12 is data stored in a memory.

Now, the following describes the autonomous movement of the autonomous vacuum cleaner 1. The movement control unit 13 controls the left and right drive motors 31 under the control of the central control means 11 so as to control the rotational directions and the rotational speeds of the left and right drive wheels 32, thereby controlling the movement of the cleaner 1. The autonomous vacuum cleaner 1 moves with reference to the map information 12 to perform the cleaning operation, and the map information 12 is renewed during the cleaning operation.

The movement control unit 13 creates map information, based on outputs of the ceiling sensor 21, the front sensors 22 and the floor sensors 5 (5a and 5b), about the area where any obstacle exists and also about the area cleaned already, and then store the information in a memory as the map information 12. The movement control unit 13 recognizes, under the control of the central control means 11, the self-position of the autonomous vacuum cleaner 1 by calculating a moving distance and self-position coordinate values of the cleaner 1, based on a moving speed obtained by time-integration of the acceleration values in the forward-backward direction detected by the acceleration sensor 25, and based on a separately measured moving time, and further based on posture direction information from the geomagnetic sensor 24.

The autonomous vacuum cleaner 1 further comprises, on the cleaner-upper-part 1a as shown in FIG. 2 and FIG. 3A, an operating unit 15 to be operated by a user, a display unit 16 composed of an LCD (Liquid Crystal Display), an informing unit (speaker) 17, and a communication module 18. The operating unit 15 is operated by a user to start and stop the cleaning operation of the cleaner 1, and to make various other settings. The display unit 16 informs operational states of the cleaner 1 and various messages. The speaker 17 informs operational states of the cleaner 1 and various messages. The communication module 18 wirelessly transmits images photographed by cameras 28 (described later) and operational states of the cleaner 1 to a main control device located at other place (not shown) via antennas 18a.

The autonomous vacuum cleaner 1 furthermore has a security function for monitoring e.g. intruders. For this function, the cleaner 1 comprises, on an outer periphery of the cleaner-upper-part 1a as shown in FIG. 2 and FIG. 3A, human sensors 26 to detect intruders, cameras 28 to photograph e.g. the intruders and a camera illumination lamp 28a. The human sensors 26, facing toward four directions of the cleaner 1, detect presence or absence of any human body around the cleaner 1 by receiving infrared radiation from the human body. The cameras 28 provided on the front of the cleaner 1 are set to face the diagonally forward-and-upward direction from the cleaner 1 so that they can photograph faces of standing humans. The autonomous vacuum cleaner 1, when not in the cleaning operation, operates these human sensors 26, cameras 28, camera illumination lamp 28a and communication module 18 so as to monitor e.g. the intruders.

Next, the cleaning function of the autonomous vacuum cleaner 1 will be described. The autonomous vacuum cleaner 1 comprises, as shown in FIG. 2 and FIG. 3B, a brush motor 41a, a power brush 41, a suction fan 42, a dust box 43 and a nozzle 44 on the cleaner-lower-part 1b for the cleaning means. The power brush 41, which brushes the floor surface, has a rotating shaft extending in a width direction perpendicular to the moving direction Z, and in addition to the power brush 41, the cleaner 1 comprises an driven roller 41b, which is driven by the power brush 41, and has a plurality of fin-like structures. The nozzle 44 provided in the vicinity of and substantially in parallel to the power brush 41 as shown in FIG. 2, sucks up dust on the floor surface through the suction force of the suction fan 42 for cleaning the floor surface of the moving path. The suction path is formed in the following order by nozzle 44, the dust box 43 which collects and stores sucked dust and the suction fan 42 which generates a suction force. It is to be noted here that the term “dust” is used in the present specification to mean dust, dirt and so on to be sucked up or collected by a vacuum cleaner.

The nozzle 44 has a nozzle opening 44a which faces a contact portion of the power brush 41 and the driven roller 41b. The power brush 41 is rotated by the brush motor 41a to brush floor surface F from back to front in the moving direction, and to move dust on the floor surface F forward and upward. The nozzle 44 sucks up, from the nozzle opening 44a, both the dust gathered up by the power brush 41 and the dust transported by the driven roller 41b, and exhausts the dust into the dust box 43. The suction fan 42 has a suction inlet which is connected to the dust box 43 via a filter (not shown), so that the sucked dust is collected by the dust box 43. The nozzle opening 44a opens elongated in a direction of the width of the autonomous vacuum cleaner 1 (left-right direction), i.e. perpendicular to the moving direction Z. Besides, the nozzle opening 44a has a valve 44b which is capable of being opened and closed by the suction force in order to prevent the dust from falling when not sucked.

Next, the function of the autonomous vacuum cleaner 1 to identify the material of the floor surface will be described. The autonomous vacuum cleaner 1, in addition to the floor sensors 5, comprises a floor surface distance calculating means 6, a floor surface identifying means 7 and a cleaning condition changing means 8, which are related to the function. Those means are formed by software, and are stored in a memory device in the control device box 10 shown in FIG. 2, and are operated by the central control means 11.

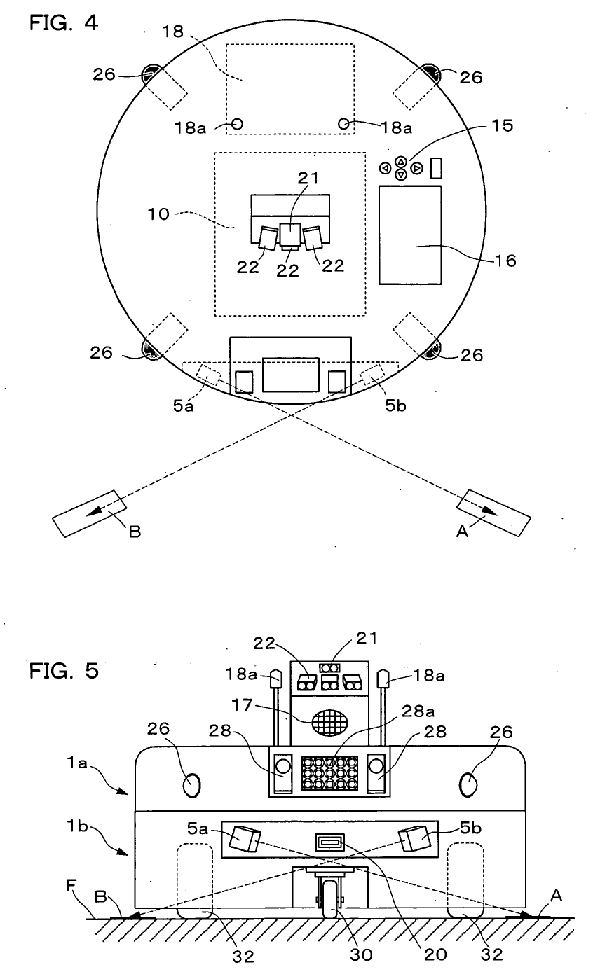

The following describes the structure and the function of the floor sensors 5. As shown in FIG. 4 and FIG. 5, the cleaner-lower-part 1b of the autonomous vacuum cleaner 1 has a pair (left and right) of floor sensors 5 (left floor sensor 5a and right floor sensor 5b) on the front thereof. The left floor sensor 5a monitors floor surface area A of the floor surface F slightly in front of and left of the cleaner 1 downward diagonally, while the right floor sensor 5b monitors floor surface area B of the floor surface F slightly in front of and right of the cleaner 1 downward diagonally, so as to see the conditions of the floor surface F, more specifically, material of the floor surface F and any step on the floor surface F.

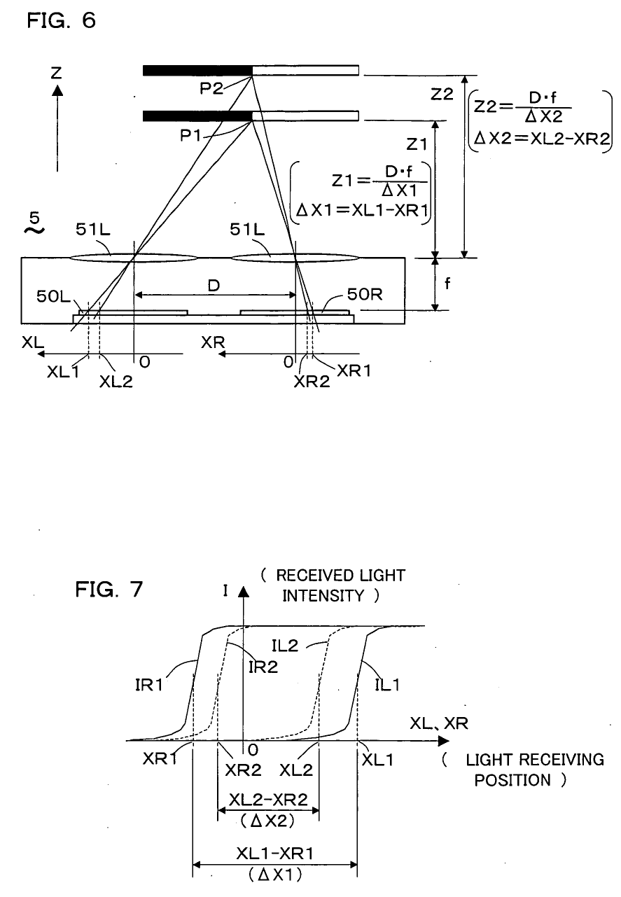

The inner structure of each of the floor sensors 5 will be described in the following. FIG. 6 shows a floor sensor 5 and its distance measurement principle, while FIG. 7 shows an example of output signal of the floor sensor 5, showing distributions of received light intensity. The floor sensor 5 comprises a passive-type line sensor to receive light from the floor surface. More specifically, the floor sensor 5 comprises an optical line sensor using e.g. CMOS (Complementary Metal Oxide Semiconductor) or CCD (Charge Coupled Device), and the line sensor forms a linear, i.e. one-dimensional, position sensitive detector (linear PSD). The depth or distance from the floor sensor 5 to the floor surface is calculated on the basis of the principle of parallax and triangulation for two light receiving areas (principle of human binocular vision) on the position sensitive detector.

As shown in FIG. 6, the floor sensor 5 comprises a pair of optical systems 51L and 51R and two light receiving areas 50L and 5OR on a line sensor, and the centerlines of them are separated from each other by a reference length D. According to this structure, images of a point corresponding to a border point P1 between black and white sections on an object located at a forward distance Z1 in the moving direction Z are focused at coordinates XL1 and XR1 on coordinate axes XL and XR defined on the light receiving areas 50L and 50R, respectively. Using a known focal length f and the above-described reference length D together with the coordinates XL1 and XR1 of the focused image points, it is possible to obtain Z1 by the equation Z1=D*f/ΔX1, where ΔX1=XL1−XR1. Similarly, the distance Z2 for a border point P2 can be obtained.

The coordinate of each of the above focused image points can be derived from the variation of received light intensity I as shown in FIG. 7. In the case of the black and white pattern shown in FIG. 6, a stepwise distribution of received light intensity can be observed, because the received light intensity I from the white section is strong, whereas the received light intensity I from the black section is weak. A certain shift between the distributions of received light intensity I for the two light receiving areas 50L and 50R is caused by the difference in distance to the object (the shift is so-called phase difference when the distributions is viewed as a waveform). Accordingly, it is possible to obtain the distance to the object by finding such shift, for example ΔX1 for point P1. In the case of a general floor surface, the distribution of light intensity received from the floor surface does not show such clear stepwise distribution. However, each distribution of light intensity received at the light receiving area 50L and 50R has substantially the same pattern and is observed with shift each other. Accordingly, it is possible to find the amount of the shift (phase difference) between the corresponding distributions of received light intensity having substantially the same pattern, and then it is possible to find unevenness of the floor surface, namely distance distribution from the floor sensor 5 to the floor surface. In other words, the floor surface distance calculating means 6 calculates distances to the floor surface and derives the distance distribution within a viewing angle of the light receiving sensor, i.e. the floor sensor 5 on the basis of correlation between received light intensities on the two light receiving areas on the position sensitive detector.

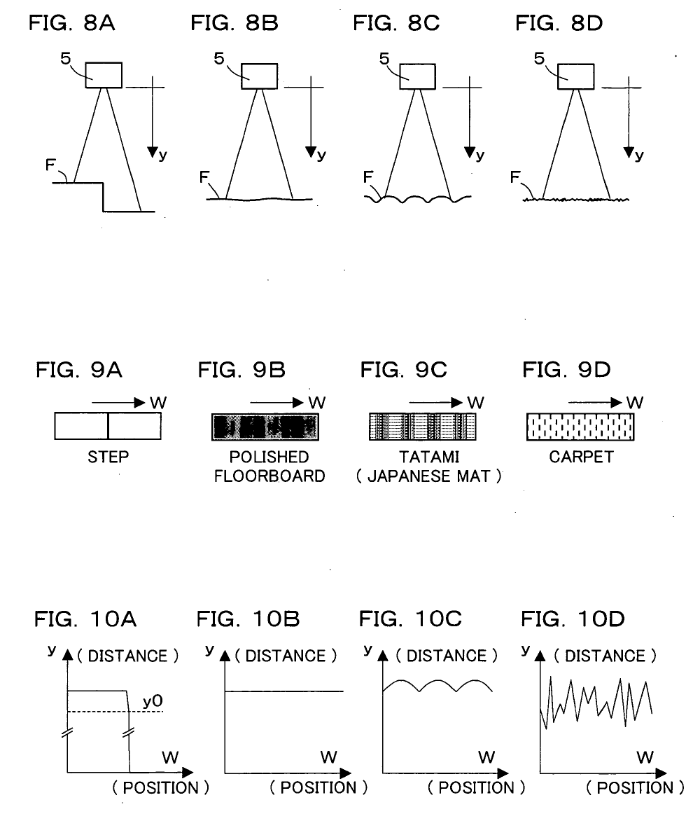

A way of identifying presence of a step on a floor and also identifying material of the floor will be described below. FIG. 8A through FIG. 8D show situations of measurements using a floor sensor 5: in the case there is a step on the floor, and in the case the materials of the floor are a polished floorboard, a tatami namely Japanese mat and a carpet, respectively. In each of FIG. 8A through FIG. 8D, reference symbol F denotes floor, and reference symbol y denotes direction from the floor sensor 5 to the floor. FIG. 9A through FIG. 9D show conceptual views of the surface conditions of the respective floors. In each of FIG. 9A through FIG. 9D, reference symbol W denotes the position in the a viewing angle of the floor sensor 5. Furthermore, each of FIG. 10A through FIG. 10D shows calculation results of a distance distribution from the floor sensor 5 to each of the four different floor surfaces within a viewing angle of the floor sensor 5 derived by the floor surface distance calculating means 6 on the basis of the phase difference between the received light intensity distributions (waveforms) at the two light receiving areas on the floor sensor 5. In each of FIG. 10A through FIG. 10D, reference symbol y denotes direction from the floor sensor 5 to the floor, and reference symbol W denotes the position in the a viewing angle of the floor sensor 5.

Those of distance distributions derived above are processed to identify floor conditions as follows. For example the distance distribution of FIG. 10A, shows a distance variation beyond a predetermined distance y0. Therefore, it is concluded that there is a step on the floor surface because. Furthermore, it becomes possible to identify the material of the floor surface. For example, a three level criterion is predetermined to apply it to a spatial frequency spectrum obtained by frequency analysis of the distance distribution, and the main frequency in the spatial frequency spectrum is compared with the criterion. Then the floor surface in the case of FIG. 10B can be identified as a polished floorboard because the main spatial frequency of distance variation is judged to be substantially zero, and the floor surface in the case of FIG. 10C can be identified as a tatami because the main spatial frequency of distance variation is judged to be low, and further the floor surface in the case of FIG. 10D can be identified as a carpet because the main spatial frequency of distance variation is judged to be high.

Those identification results coincide with results obtained by ordinary visual and sensory observation, that is, a polished floorboard is observed to have a substantially constant distance distribution within substantially entire range of distance measurement, and a tatami is observed to have a constantly repeated uneven distance distribution, and a carpet is observed to have a distance distribution composed of shorter distances than in the case of polished floorboard and further a carpet is observed to have an irregular distance distribution within distance measuring range. These spatial frequency analysis and identification are performed by the above-described floor surface identifying means 7. As evident from the above, the floor sensor 5 can be used as both a step detection sensor and a floor surface identification sensor.

When the material of the floor is identified by the floor surface identifying means 7, cleaning conditions including at least the moving speed, the dust suction force of the suction fan 42 or the brushing strength of the power brush 41 are changed by the cleaning condition changing means 8 on the basis of the result of the identification made by the floor surface identifying means 7 during the time the autonomous vacuum cleaner 1 moves while cleaning. Thereby, it becomes possible to efficiently perform desired cleaning of floor surface without damaging the floor surface. Such change of the cleaning conditions is made by the above-described cleaning condition changing means 8.

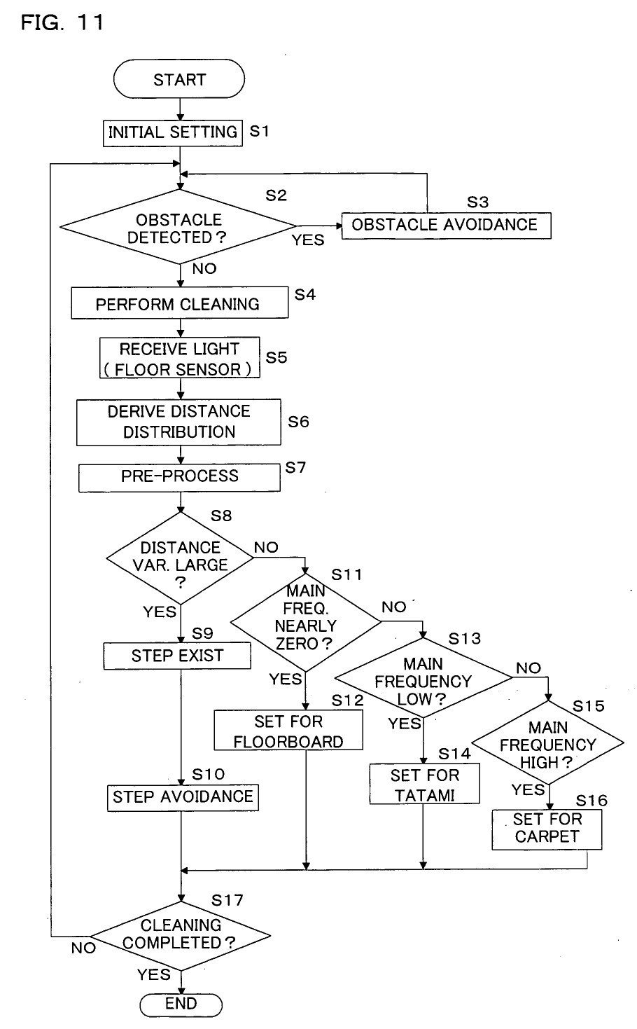

Hereinafter, referring to the flow chart of FIG. 11 and also to FIG. 1 in some instances, the autonomous cleaning process will be described, which process is performed by the autonomous vacuum cleaner 1 comprising the floor sensors 5 and the above-described means to enable the cleaner 1 to process a floor surface of various conditions. First, the autonomous vacuum cleaner 1: sets initial settings such as an initial setting of cleaning area (S1); thereafter performs obstacle detection operation using the obstacle detection sensors (ceiling sensor 21 and front sensors 22) as it starts moving; performs obstacle avoidance operation (S3) if an obstacle is detected in the moving direction (YES in S2); and performs cleaning by autonomously moving on a predetermined moving path in a predetermined cleaning area (S4) if an obstacle is not detected (NO in S2).

Subsequently, the floor sensors 5 receive light reflected from a floor surface (S5) and output received signals, which are input to the floor surface distance calculating means 6 and the means 6 derives a calculated distance distribution by calculation (S6). Thereafter, the floor surface identifying means 7 performs a pre-process of identifying the floor surface such as detection of distance variation and analysis of spatial frequency in the calculated distance distribution (S7). Subsequently, the floor surface identifying means 7 performs a series of comparisons and identifications as follows. First, if the distance variation in the calculated distance distribution is larger than a predetermined value (YES in S8), it is concluded that there is a step on the floor surface (S9), and then the autonomous vacuum cleaner 1 performs step avoidance operation by using the movement control unit 13 via the central control means 11 (S10).

If the distance variation is smaller than or equal to the predetermined value (NO in S8), the floor surface identifying means 7 performs a comparison and identification based on a main frequency in the spatial frequency spectrum in the distance distribution. If the main spatial frequency is substantially zero (YES in S11), the material of the floor surface is identified as a polished floorboard Based on this result, the cleaning condition changing means 8 sets the cleaning means to be for polished floorboard (S12).

If the material of the floor surface is not identified as a polished floorboard (NO in S11), a subsequent comparison and identification is performed, that is, if the main spatial frequency is lower than or equal to a predetermined value (YES in S13), the material of the floor surface is identified as a tatami. Based on this result, the cleaning condition changing means 8 sets the cleaning means to be for tatami (S14). Similarly, if the material of the floor surface is not identified as a tatami (NO in S13), a subsequent comparison and identification is performed, that is, if the main spatial frequency is higher than the predetermined value (YES in S15), the material of the floor surface is identified as a carpet. Based on this result, the cleaning condition changing means 8 sets the cleaning means to be for carpet (S16).

After the above series of identifications and cleaning condition settings are completed, the map information 12 is referred to see whether the cleaning for the predetermined cleaning area being completed or not, and if completed the cleaning process ends (YES in S17). On the other hand, if the cleaning is not completed (NO in S17), the above steps from step S2 onward are repeated. The central control means 11 of the autonomous vacuum cleaner 1 repeats these steps at predetermined time intervals to perform the cleaning process.

It is to be noted that the present invention is not limited to the above described structures, configurations or processes, and various modifications are possible. For example, without using the floor sensor 5 both as step detection and floor surface identification, separate exclusive sensors, i.e. not dual-purpose sensors, can be used for step detection and floor surface identification, respectively. Furthermore, the mounting positions and the sensing directions of the above-described various sensors are not limited to those illustrated above.

This application is based on Japanese patent application 2004-022408 filed in Japan dated Jan. 30, 2004, the contents of which are hereby incorporated by reference.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. An autonomous vacuum cleaner comprising:
a cleaning means to clean a floor surface where the cleaner moves;
an obstacle detection sensor to detect an obstacle on the cleaner's way and to measure distance to the obstacle;
a moving means with which the cleaner moves autonomously in accordance with an output of the obstacle detection sensor to avoid the obstacle;
a light receiving sensor having a passive-type line sensor to receive light from a floor surface; and
a floor surface distance calculating means which derives distribution of distances to the floor surface within a viewing angle of the light receiving sensor on the basis of correlation between received light intensities on two light receiving areas of the line sensor,
wherein the moving means and the cleaning means are controlled on the basis of the distance distribution derived by the floor surface distance calculating means.

2. The autonomous vacuum cleaner according to claim 1, which further comprises a floor surface identifying means to identify material of the floor surface on the basis of the distance distribution derived by the floor surface distance calculating means, wherein the moving means and the cleaning means are controlled depending on the material of the floor surface identified by the floor surface identifying means.

3. The autonomous vacuum cleaner according to claim 2,
wherein the passive-type line sensor is of CMOS, and
wherein the cleaning means includes:
a power brush having a rotating shaft extending in a width direction perpendicular to the moving direction of the cleaner to brush the floor surface;
a suction fan to generate dust suction force; and
a nozzle provided in the vicinity of and substantially in parallel to the power brush to suck up dust on the floor surface using the suction force of the suction fan, and thereby to clean the floor surface where the cleaner moves.

4. The autonomous vacuum cleaner according to claim 3, which further comprises a cleaning condition changing means to change cleaning conditions including at least one of the moving speed of the cleaner, dust suction force of the suction fan, or brushing strength of the power brush on the basis of the floor material identification made by the floor surface identifying means during the cleaning,
wherein the floor surface identifying means identifies: that there is a step on the floor surface if there exists larger distance variation than a predetermined distance in the distance distribution; that the material of the floor surface is a polished floorboard if a main spatial frequency of the distance variation is substantially zero; that the material of the floor surface is a tatami if the main spatial frequency is low; and that the material of the floor surface is a carpet if the main spatial frequency is high, and
wherein the light receiving sensor is used both as a step detection sensor and a floor surface identification sensor.
